(19) United States
(12) Patent Application Publication
(10) Pub. No.: US 2007/0007080 A1
(43) Pub. Date: Jan. 11, 2007

(54) Industrial truck with an electrical control unit

(75) Inventors: Maik Manthey, Wedel (DE); Joachim Todter, Hamburg (DE)

Correspondence Address: THE WEBB LAW FIRM, P.C., 700 KOPPERS BUILDING, 436 SEVENTH AVENUE, PITTSBURGH, PA, 15219, US

(73) Assignee: STILL GmbH, Hamburg (DE)

(21) Appl. No.: 11/443,467

(22) Filed: May 30, 2006

(30) Foreign Application Priority Data
May 31, 2005 (DE) 10 2005 024 881.0

(51) Int. Cl. B66F 9/20

(52) U.S. Cl. 187/224

(57) ABSTRACT

An industrial truck includes at least one electronic control unit for traction functions and/or lifting functions of the industrial truck and at least one communications device for data transfer with object identification means, such as with RFID transponders. Connections can be provided for the transmission of data between the communications device and the electronic control system for traction functions and/or lifting functions of the industrial truck.

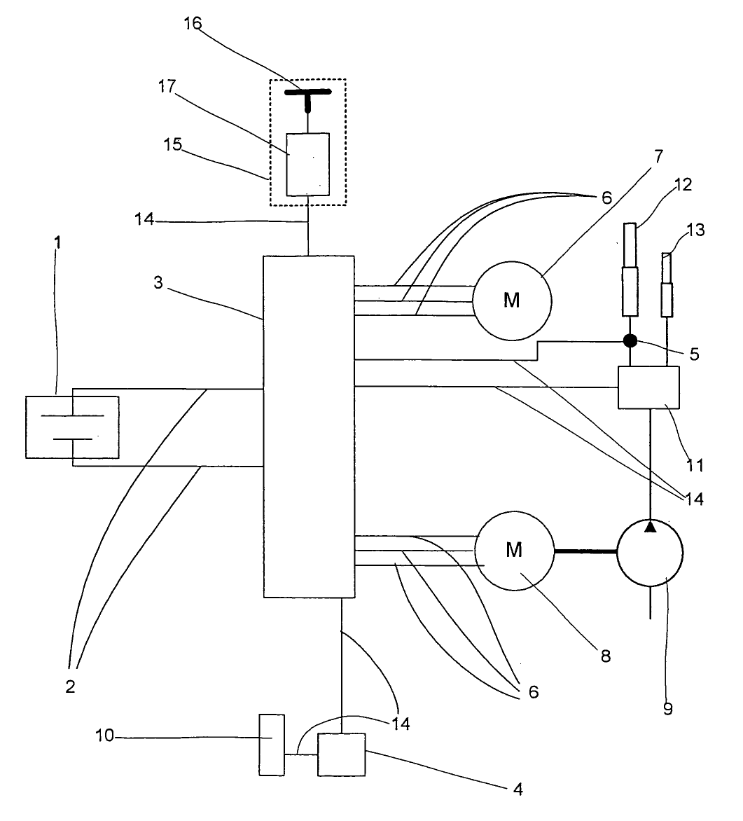

### CROSS-REFERENCE TO RELATED APPLICATION

This application claims priority to German Application No. 10 2005 024 881.0, filed May 31, 2005, herein incorporated by reference in its entirety.

### BACKGROUND OF THE INVENTION

1. Field of the Invention

This invention relates to an industrial truck with at least one electronic control system for traction functions and/or lifting functions of the industrial truck, and at least one communications device for data transfer with object identification means, such as with RFID transponders.

2. Technical Considerations

For the actuation of the traction and lifting functions of an industrial truck, an electronic control unit is generally used to actuate drive motors, lifting drives, hydraulic valves, and brakes, for example, to carry out the commands that are issued, such as by an operator via corresponding control elements. To an increasing extent, communications devices are also installed on industrial trucks to make possible data transfer from and/or to object identification means. Object identification means of this type can be bar code labels, for example, or REID tags, i.e., transponders, that transmit information via radio frequencies. Using object identification means of this type, it is possible to identify a cargo or a load carrier means, such as a pallet, for example, as well as, optionally, additional information relating to the cargo, such as, for example, its weight and/or destination. Identification means of this type can also be used to transmit position information to the industrial truck by using transponders that are installed in a fixed and stationary position, which transmit data to the industrial truck as it drives past the transponders. For example, the information from fixed transponders can be used to determine the current position as well as location-related information, such as the ceiling height or aisle widths in a warehouse.

However, when RFID transponders are used for'object identification, a series of problems can arise that must be taken into consideration by the operator. For example, in warehouses in which the loads to be picked up are located relatively close to one another, the communication device can receive signals from more than one transponder. The result may be some uncertainty about which load is to be picked up, or even the load that has already been picked up. The permanent operation of the communications device and the resulting increased energy consumption also limit the range and, thus, the productivity of the industrial truck. If special measures are necessary in the operation of the industrial truck on account of the characteristics of the cargo or the environment, such as reduced speed or a limitation in the height to which the cargo can be lifted, the operator must first be able to read the information on the cargo, such as the weight of the cargo, for example, or the ceiling height in the warehouse, by means of the cargo identification or the position information, and then to adjust the commands accordingly.

These conditions and problems slow down the logistics operations and divert the operator's attention from the tasks at hand, which increase the risk of errors and accidents. To prevent errors and accidents, the operator must concentrate more closely, which rapidly leads to fatigue.

Therefore, it is an object of the invention to provide an industrial truck with at least one electronic control system for the traction functions and/or lifting functions of the industrial truck, and with at least one communications device for the transfer of data with object identification means, such as with RFID transponders, that makes possible easier operation, a higher level of safety, and more efficient management of energy supplies.

### SUMMARY OF THE INVENTION

The invention teaches that this object can be accomplished by providing means for the transmission of data between the communications device and the electronic control system for at least one traction function and/or at least one lifting function of the industrial truck. As a result of the transmission of information from the electronic control system to the communications device and/or vice versa, the function of both components can be better coordinated with each other. The intermediate step via the operator, who must receive the information from the one system and then use it for the operation of the other system, for example to identify the weight of the cargo by means of the cargo identification and to reduce the speed of travel accordingly, can thereby be eliminated. As a result of which, the safety of the overall operation is improved.

It is particularly advantageous if the communications device for the data transfer can be used with stationary and permanently installed devices for the transmission of position-related information. In addition to information that relates to the specific object, it is also frequently desirable to transmit information related to locations to an industrial truck. By using the same communications device for both types of information, it becomes possible to achieve a particularly simple construction of the industrial truck.

In one advantageous embodiment, the means for data transmission comprise at least one cable connection. Cable connections are simple, reliable, and economical. The transmission of large amounts of data is easily possible and consumes little energy.

In an additional advantageous realization of the invention, the means for data transmission comprise at least one optical connection, such as by means of glass fibers. Connections of this type are reliable and make possible the transmission of large amounts of data.

It is also advantageous if the means for data transmission comprise means for wireless transmission, such as by means of radio waves. Wireless transmission makes possible a relatively flexible positioning of the components because there are no cable routings that have to be taken into consideration. Wireless transmission is also immune to physical damage to the cables. Wireless components are particularly advantageous for components that are mobile relative to one another, for example, a communications device that is attached to a fork carrier and a control system installed in the vehicle.

It is appropriate if the means for the data transmission are suitable for the use of a standardized transmission protocol, such as using a bus system, such as a conventional CAN bus. The use of standardized transmission protocols, in combination with a bus system, makes it possible to use conventional and, thus, reliable and operationally reliable and economical components.

It is particularly advantageous if means are provided for the activation and/or deactivation of the communications device as a function of the operating parameters of the industrial truck, such as of the speed and/or acceleration of travel and/or the inclination of the mast and/or the weight of the load and/or the lifting height and/or the vehicle position. Because the communications device can be activated and/or deactivated as a function of the operating parameters of the industrial truck, the communications device is active only when it is appropriate or needed. This feature eliminates the unnecessary consumption of energy. The security of the transmission of information is also improved because signals can be received only if the current status of the industrial truck requires or allows the reception. The occurrence of interfering signals can thereby be significantly reduced.

It is, likewise, particularly advantageous if means are provided to influence vehicle functions, such as the speed of travel and/or acceleration and/or lifting height and/or mast inclination, as a function of the information from the communications device. For example, when the communications device is used for position determination, a position- dependent command of maximum speed or lifting height can be given to avoid accidents in tight spaces or in areas with low ceilings. The identification of the load by means of the communications device can be used to determine the weight of the load or special characteristics, and to set the vehicle parameters so that the load can be transported particularly safely. The safety and efficiency of the industrial truck are thereby both increased.

It is also advantageous if means are provided for a comparison of the information obtained via the communications device and the information obtained by means of the vehicle control system. The information can thereby be verified. For example, the load weight measured by a measurement device can be compared with a load weight that is determined directly or indirectly on the basis of the identification data. If the difference exceeds a specified limit value, suitable measures can be taken, e.g., a message to the operator or a restriction of vehicle functions.

### BRIEF DESCRIPTION OF THE DRAWING

Additional advantages and details of the invention are explained in greater detail below on the basis of the exemplary embodiment illustrated in the accompanying drawing. The figure is a schematic illustration of the wiring plan for a counterweighted fork-lift truck, as one example of an industrial truck of the invention.

### DESCRIPTION OF THE PREFERRED EMBODIMENT

A power source, for example a battery 1, supplies an electronic control system 3 with electrical energy via feed lines 2. The control system 3 receives control commands from an operator via an operating unit 4. The measurements from sensors, for example a pressure sensor 5 in the hydraulic circuit, are also processed in the control unit 3. As a function of these inputs, the control system 3 sends power signals via feed lines 6 to a traction drive motor 7 and to a drive motor 8 of a hydraulic pump 9. Information is also transmitted to display elements 10 for the operator and to a hydraulic valve block 11. The hydraulic valve block 11 is used to actuate hydraulic functions. In the illustrated exemplary embodiment, these functions are a lifting cylinder 12 and a tilting cylinder 13. The lifting cylinder 12 is used to raise load-handling means (not shown here), which are guided on a load mast (also not shown). The tilting cylinder 13 can be used to set the inclination of the lifting mast. The operating unit 4, like the display elements 10, the pressure sensor 5, and the hydraulic valve block 11 are connected to the control system 3 by means of a CAN bus connection 14.

A communications device 15 for data transfer with object identification means, which comprises essentially an antenna 16 for the transmission and reception of RFID signals and an electronics unit 17 for the actuation of the antenna 16 and for the processing of the signals coming from the antenna 16, is also effectively connected via a CAN bus connection 14 with the control system 3.

The communications device 15 is attached to the industrial truck in a suitable location so that it can communicate both with RFID transponders that are attached to the load as well as with transponders that are permanently installed in fixed positions. Transponders on the load can be attached both to the load itself as well as to the load-carrying means, such as a pallet, for example, and in addition to data that are used for the identification of the cargo or of the load carrier, can also receive additional information, such as, for example, the current storage location, the destination, or the weight of the load. Transponders that are installed in a stationary and permanent location are used primarily for the transmission of position-related information, and, therefore, in addition to the location, for example, can also transmit information relating to the maximum allowable speeds of transport and vehicle weights or lifting heights. Transponders of this type are preferably located in the roadway and are read as the vehicle travels over them. To be able to read both types of transponders as accurately as possible, the antenna 16 is located on one of the tines of the load fork of the industrial truck, although other configurations are also conceivable.

The communications device 15 is activated and deactivated as a function of the speed of travel of the industrial truck. When the speed of travel of the industrial truck drops below a limit value, the communications device 15 is activated because, in that case, it can be assumed that a load is to be picked up or put down. In the illustrated exemplary embodiment, the limit value is a speed of 3 km/h, although the operator can also change this value via inputs on the operating unit 4 to make possible an optimal adaptation to the current operating conditions. If the industrial truck travels faster than the specified limit value, it can be assumed that the industrial truck is either transporting a load or is traveling without a load on the way to picking up a new load. In both cases, no reading of the identification is necessary and power is conserved for the operation of the truck by deactivating the communications device 15 in a way that prevents signals from other transponders, past which the industrial truck moves, from being picked up and resulting in erroneous information.

Alternatively or additionally, other parameters of the industrial truck that are measured in the control system 3 can also be used to affect the activation and/or deactivation of the communications device 15. These parameters can comprise, for example, the activation of certain functions of the valve block 11. For example, when the load mast is tilted backward, the communications device 15 can be deactivated because this position is also typically assumed during the transport of loads while, when the load mast is in the vertical position or is tilted slightly forward, the vehicle is typically carrying a load. An activation as a function of the weight of the load or changes in the weight of the load, which can be determined, for example, on the basis of the measurements from the pressure sensor 5 or from changes in the speed of the pump 9 or of the motor 8, is also conceivable. Changes in the weight of the load, in particular, are reliable indicators that a load has been picked up or put down.

If the communications device 15 detects signals from an RFID transponder, the information transmitted by the transponder is transmitted to the control system 3. As a function of the data transmitted from the transponder, the control system 3 defines parameters for the industrial truck, i.e., for example, after the identification of a load as sensitive, there could be a reduction in the acceleration and in the maximum speed of the industrial truck. For particularly heavy loads, for example, the lifting height can be limited and/or the speed of travel of the industrial truck can be limited to reduce the danger of tipping.

The control system 3 also performs a comparison of the information transmitted by an RFID transponder with values measured using other means, such as with measurements from sensors on the industrial truck. For example, a load weight that is determined from the transponder data can be compared with the load weight determined by means of the pressure sensor 5. If the difference exceeds a specified limit, the operator is so informed by means of the display elements 10 and can initiate countermeasures, i.e., the operator can verify whether the load picked up matches the information from the transponder or whether there has been an error in the measurement of the load weight by the industrial truck.

If the industrial truck is operated in areas in which fixed transponders are installed for the transmission of position-related information, a mode of operation can be selected that takes this fact into account and, therefore, differs to some extent from the mode of operation described above. The selection can be made either via control elements on the operating unit 4 by the operator, by measures that are taken during the manufacture and/or service of the industrial truck, or automatically when a corresponding control signal is received by the communications device 15. In this mode of operation, the communications device 15 is not automatically deactivated when the vehicle is traveling but is optimized for the reception of signals from fixed transponders, for example by a frequency change that may be necessary. The switch from the detection of transponders attached to the load to the detection of signals from fixed transponders can be made on the basis of operating parameters of the industrial truck. In addition to the speed of travel, in which case the switch occurs at a specified speed of travel, additional factors that can be taken into consideration include the lifting height. Fixed transponders for the transmission of position-related information are generally located in the vicinity of the roadway. To create the best possible reception conditions, the antenna 16 should, therefore, be positioned as close to the roadway as possible. Because the antenna 16 is located on one of the tines of the load fork of the industrial truck, it has sufficient reception conditions only when the truck is traveling with the load-handling means lowered. A switch from the reading of load-related transponders to fixed transponders therefore occurs only when the lifting height falls below a specified limit. When the industrial truck is traveling with insufficiently lowered load-handling means, the communications device 15 is deactivated and a warning signal is given to the operator by means of the display elements 10. Depending on the application, it is also conceivable to switch from one mode of operation to the other only when loads are being transported, i.e., as a function of the weight of the load.

The position-related data are transmitted by the communications device 15 to the control system 3. The operating parameters of the industrial truck can be modified on the basis of these data. For example, the lifting height can be automatically limited for areas in which the ceiling height is lower than the maximum lifting height of the industrial truck. If areas with a reduced allowable maximum speed of travel are identified by fixed transponders, the control system 3 automatically limits the speed of travel of the industrial truck. In areas with reduced load-carrying capacity of the surface on which the truck will travel, a warning signal is sent to the operator when an industrial truck that exceeds the allowable weight enters the area and the vehicle is stopped by the control system 3.

By means of a comparison of the position data for the destination, which were transmitted from a transponder that is associated with the load, and the current position, which is determined by means of a fixed transponder, it can be determined whether the industrial truck is on the correct route and, if not, an alarm message can be sent to the operator. The misplacement of items, in particular in large operating areas, can thereby be prevented. If the entrances to loading and unloading areas are identified by fixed transponders, when an industrial truck enters these areas, the communications device 15 can be automatically switched to detect load-related transponders.

It goes without saying that configurations other than the illustrated exemplary embodiment are possible, for example, configurations that include a plurality of control systems for different functions of the industrial truck which communicate with one another or with a central unit by means of a bus system. The use of a wireless connection between the control system 3 and the communications device 15 is also possible, for example, by means of radio or optical signals, such as infrared radiation or by means of a fiber optics connection. An additional configuration would be the integration of the communications device 15 into the control system 3, which would then communicate either directly with RFID transponders and/or by means of a transmitter and receiver unit that acts as a relay station and merely implements the signals from transponders and/or the communications device 15. This relay station could be installed in a position that is advantageous in terms of operation and could be constructed without its own evaluation unit. Instead of a communications device 15 with an antenna 16 that is capable of reading signals both from fixed transponders and from transponders that are attached to the load, the use of two or more different communications devices 15 is also conceivable, or of one communications device 15 with two or more antennas 16 to pick up signals from different types of transponders. On communications devices 15 on which the area covered by the antenna 16 can be varied, for example, by pivoting the antenna 16, this variation can be initiated as a function of the operating parameters of the industrial truck, i.e., for example, by selecting different areas for picking up and setting down loads and during travel. On vehicles with a hybrid propulsion system, a distinction is also conceivable between indoor and outdoor areas so that the more advantageous propulsion source is selected automatically.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An industrial truck, comprising:
at least one electronic control unit for traction functions and/or lifting functions of the industrial truck;
at least one communications device for data transfer with object identification means; and
means for the transmission of data between the communications device and the electronic control system for the traction functions and/or lifting functions of the industrial truck.

2. The industrial truck as claimed in claim 1, wherein the communications device for the data transfer with fixed devices is suitable for the transmission of position-related information.

3. The industrial truck as claimed in claim 1, wherein the means for data transmission comprise at least one cable connection.

4. The industrial truck as claimed in claim 1, wherein the means for data transmission comprise at least one optical connection.

5. The industrial truck as claimed in claim 1, wherein the means for data transmission comprise means for wireless transmission.

6. The industrial truck as claimed in claim 1, wherein the means for data transmission are suitable for the use of a standardized transmission protocol.

7. The industrial truck as claimed in claim 1, including means for at least one of activation and deactivation of the communications device as a function of operating parameters of the industrial truck.

8. The industrial truck as claimed in claim 1, including means to influence vehicle functions as a function of information from the communications device.

9. The industrial truck as claimed in claim 1, including means for comparison of information received by the communications device and information received by the electronic control system for traction functions and/or lifting functions of the industrial truck.

10. The industrial truck as claimed in claim 1, wherein the object identification means comprise RFID transponders.

11. The industrial truck as claimed in claim 4, wherein the optical connection comprises glass fibers.

12. The industrial truck as claimed in claim 5, wherein the wireless transmission is via radio waves.

13. The industrial truck as claimed in claim 6, wherein the means for data transmission include a CAN bus system.

14. The industrial truck as claimed in claim 7, wherein the operating parameters include at least one parameter selected from the group consisting of the speed of travel, acceleration, the inclination of the mast, the weight of the load, the lifting height, and the position of the vehicle.

15. The industrial truck as claimed in claim 8, wherein the vehicle functions include at least one function selected from the group consisting of the speed of travel and/or acceleration and/or the lifting height and/or the inclination of the mast.
